(19) United States
(12) Patent Application Publication
(10) Pub. No.: US 2014/0054177 A1
(43) Pub. Date: Feb. 27, 2014

(54) TRANSPARENT PLASTIC FILM THAT CAN BE ELECTROPLATED FOR PARTIAL ELECTROPLATING

(71) Applicants: Matthias Grötsch, Kitzingen (DE); Georgios Tziovaras, Wuppertal (DE); Heinz Pudleiner, Krefeld (DE); Roland Künzel, Leverkusen (DE)

(72) Inventors: Matthias Grötsch, Kitzingen (DE); Georgios Tziovaras, Wuppertal (DE); Heinz Pudleiner, Krefeld (DE); Roland Künzel, Leverkusen (DE)

(73) Assignee: BAYER INTELLECTUAL PROPERTY GMBH, Monheim (DE)

(21) Appl. No.: 14/003,783

(22) PCT Filed: Mar. 6, 2012
(86) PCT No.: PCT/EP2012/053809

§ 371 Date: Nov. 12, 2013

(30) Foreign Application Priority Data
Mar. 10, 2011 (EP) 11157746.6

(51) Int. Cl. B32B 27/08; C25D 5/56

(52) U.S. Cl. CPC B32B 27/08; C25D 5/56
USPC 205/118; 428/334; 428/215; 428/141; 428/335; 428/336

(57) ABSTRACT

The present invention relates to an electroplatable plastics film having a light transmission greater than 50%, particularly preferably greater than 80%, for the production of metallised components, in particular partially metallised components.

The present invention relates to an electroplatable plastics film having a light transmission greater than 50%, particularly preferably greater than 80%, for the production of metallised components, in particular partially metallised components.

Partially metallised plastics mouldings having symbols which can be backlit are of great interest in particular for operating elements, for example, for the automotive interiors sector, but also for the aircraft interiors sector or railway vehicle interiors sector for better operability in darkness.

Such plastics mouldings are today preferably metallised by means of partial electroplating.

A requirement for good metallisation of plastics materials is sufficient adhesion between the metal layer and the plastics material. This has to be achieved for each plastics material by means of a different pretreatment. Not every plastics material can be rendered conductive with an acceptable outlay, and the ABS plastics materials (acrylonitrile-butadiene-styrene copolymers) and blends thereof with polycarbonate(s) have therefore become established in practice.

Various processes for the partial electroplating of plastics components are known to the person skilled in the art. For a long time, partially chromium-plated plastics parts could be produced only by means of 2-component (2K) technology. Electroplatable plastics material formed the substrate for the gloss layer, non-electroplatable granulate was used where no metal was to adhere. The disadvantage of such processes is that a 2K tool and an injection moulding machine with two units are required. In addition, from an injection moulding point of view, it is often not possible to achieve chromium-free parts where they are desired (see Innovation, Magazin for KH-Partners, No. 15, June 2007, p. 1-3, publisher: Kunststoff Helmbrechts AG).

In the newer folioPlate® process, an electroplatable film is formed, stamped and back moulded with a plastics material that cannot be coated by electroplating. In the subsequent electroplating bath, the metal is deposited only on the film; the remainder of the body of the part remains free (see Innovation, Magazin for KH-Partners, No. 15, June 2007, p. 1-3, publisher: Kunststoff Helmbrechts AG). Although 2K tools and complex masking technology can thereby be avoided, the parts of the component that have been left free can be provided with a decoration, especially a multicoloured decoration, only with a great outlay.

A further process for the partial electroplating of plastics mouldings is described in DE 102 08 674 A1. In that process, injection mouldings of electroplatable ABS or ABS/PC blends are partially galvanised, but areas on the rear side must first be covered in order to avoid metallisation and the covering must be removed again following the electroplating process. A further disadvantage of this process is the poor light transmission of the electroplatable plastics materials that are used, so that a high energy outlay is required for backlighting. Also, the areas of the component that have been freed by lasering or by etching can be provided with a decoration, especially a multicoloured decoration, only with a great outlay.

DE 103 07 334 A1 discloses a process for the production of a plastics moulding by means of two-component injection moulding, in which an electroplatable ABS layer is applied to a non-electroplatable polycarbonate base body. A disadvantage of this process is, however, on the one hand that it is generally not possible by means of two-component injection moulding to produce layers having sufficient transparency for, for example, multicoloured backlighting. On the other hand, it is necessary in such a process to prepare a separate injection moulding tool for each different forming of the metallisable plastics moulding. The process does not offer any flexibility in terms of design.

WO 2004/099460 A2 discloses a process for the production of optionally transilluminated moulded bodies enhanced by electroplating, in which an opaque or coloured layer of a lacquer comprising an electroplatable plastics material is applied to a finished transparent plastics moulded body. ABS is mentioned as an example of an electroplatable plastics material. This process is disadvantageous, however, in that, on the one hand, in the lacquering of plastics materials which, like ABS, are not water-soluble, the problem of removing organic solvents must be solved, which leads to an additional outlay in terms of process technology and disposal. On the other hand, an opaque lacquer layer reduces the transparency for the transillumination, or colouring of the lacquered layer does not introduce any flexibility as regards multiple colours of the areas that are to be backlit. In addition, because of their roughness, lacquered surfaces have a so-called “orange peel effect” which is noticeable with the naked eye; this would be transferred to an electroplated metal surface and would on no account give an observer the impression of a smooth metal surface.

Accordingly, there was a continued need for a possibility of producing partially metallised plastics mouldings which do not have the above-mentioned disadvantages in a simple manner by means of electroplating.

The object underlying the present invention was accordingly to find materials and a process for the production of plastics mouldings that are partially metallised by means of electroplating, which materials and process permit such production with as few process steps as possible. It is also to be possible to provide the backlightable areas with a multicoloured decoration in a simple manner and to effect backlighting with as low an energy outlay as possible. In addition, flexibility in terms of the forming of the mouldings is to be provided in a simple manner

The object is achieved, surprisingly, by the use of a plastics film comprising
at least one layer comprising at least one polycarbonate and
at least one layer comprising at least one vinyl polymer,

wherein the layer(s) A comprising polycarbonate and the layer(s) B comprising at least one vinyl polymer have been coextruded, and the layer comprising at least one vinyl polymer has a layer thickness of 100 μm or less and the plastics film has a transmission in the visible wavelength range of more than 50%,

in a process for metallisation, preferably by means of electroplating.

The plastics film according to the invention is metallisable only on the side that has the layer comprising at least one vinyl polymer, so that laborious covering of all or part of the rear side is not necessary. In addition, owing to the high light transmission in the visible wavelength range, backlighting is possible with a low energy outlay. Because the plastics film, before it is processed further, can be printed in known manner, optionally also with multicoloured print, on the side of the polycarbonate-containing layer, single- or multi-colour decoration of the backlit regions is also possible in a simple manner. In addition, the plastics film can be formed by means of known forming processes, so that mouldings of very different forms can be produced therefrom.

Accordingly, the present invention provides the use of a plastics film comprising
at least one layer A comprising at least one polycarbonate and
at least one layer B comprising at least one vinyl polymer,

characterised in that the layer(s) A comprising polycarbonate and the layer(s) B comprising at least one vinyl polymer have been coextruded, and the layer B comprising at least one vinyl polymer has a layer thickness of 100 μm or less and the plastics film has a transmission in the visible wavelength range of more than 50%,

in the production of metallised components, wherein the metallisation is preferably carried out by means of electroplating.

The plastics film is preferably suitable for the production of partially metallised components, wherein the metallisation is carried out by means of partial electroplating.

The present invention further provides the electroplatable plastics film comprising
at least one layer A comprising at least one polycarbonate and
at least one layer B comprising at least one vinyl polymer,

characterised in that the layer(s) A comprising polycarbonate and the layer(s) B comprising at least one vinyl polymer have been coextruded, and the layer B comprising at least one vinyl polymer has a layer thickness of 100 μm or less and the plastics film has a transmission in the visible wavelength range of more than 50%.

Preferably, the total thickness of the plastics film according to the invention is 1000 μm or less, particularly preferably 750 μm or less, most particularly preferably 600 μm or less.

In preferred embodiments, no further layers are present between layers A and B.

In a most particularly preferred embodiment, the plastics film according to the invention comprises one layer A and one layer B. Preferably, layer B can be printed on the side that is not in contact with layer A.

In preferred embodiments, however, the film according to the invention can also be a multilayer structure which comprises more than one layer A and/or B. A preferred embodiment is such a multilayer structure in which at least one layer A is located between at least two, preferably two, layers B. In preferred embodiments, however, the film according to the invention can also be a multilayer structure which has further layers between the layer(s) A and B. In preferred embodiments, however, the film according to the invention can also be a multilayer structure which has further layers between the layer(s) A and B and or on layer A facing outwards.

Polycarbonates that are suitable according to the invention for the layer(s) A are all known polycarbonates. They can be, for example and preferably, homopolycarbonates, copolycarbonates and thermoplastic polyester carbonates.

Preferably, the polycarbonates have mean molecular weights M̅_{w} of from 10,000 to 100,000, preferably from 15,000 to 50,000, particularly preferably from 20,000 to 40,000 and most particularly preferably from 24,000 to 35,000, determined by measuring the relative solution viscosity at 25° C. in dichloromethane or in mixtures of equal amounts by weight phenol/o-dichlorobenzene calibrated by light scattering.

The preparation of polycarbonates is known to the person skilled in the art. Reference may be made, for example, to “Schnell, Chemistry and Physics of Polycarbonates, Polymer Reviews, Vol. 9, Interscience Publishers, New York, London, Sydney 1964”, and to “D. C. PREVORSEK, B. T. DEBONA and Y. KESTEN, Corporate Research Center, Allied Chemical Corporation, Moristown, N.J. 07960, ‘Synthesis of Poly(ester)carbonate Copolymers’ in Journal of Polymer Science, Polymer Chemistry Edition, Vol. 19, 75-90 (1980)”, and to “D. Freitag, U. Grigo, P. R. Muller, N. Nouvertne, BAYER AG, ‘Polycarbonates’ in Encyclopedia of Polymer Science and Engineering, Vol. 11, Second Edition, 1988, pages 648-718” and finally to “Dres. U. Grigo, K. Kircher and P. R. Muller ‘Polycarbonate’ in Becker/Braun, Kunststoff-Handbuch, Volume 3/1, Polycarbonate, Polyacetale, Polyester, Celluloseester, Carl Hanser Verlag Munich, Vienna 1992, pages 117-299”.

Dihydroxyaryl compounds suitable for the preparation of polycarbonates that are preferred according to the invention are those of the general formula (1)

HO—Z—OH (1)

wherein
Z is an aromatic radical having from 6 to 30 carbon atoms which can contain one or more aromatic nuclei, can be substituted and can contain aliphatic or cycloaliphatic radicals or alkylaryls or heteroatoms as bridge members.

Z in the general formula (1) preferably represents a radical of the general formula (1a)

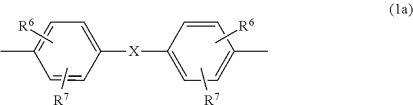

wherein
R⁶ and R⁷ independently of one another represent H, C₁-C₁₈-alkyl, C₁-C₁₈-alkoxy, halogen such as, for example, Cl or Br, or optionally substituted aryl or aralkyl, preferably H or C₁-C₁₂-alkyl, particularly preferably H or C₁-C₈-alkyl and most particularly preferably H or methyl, and
X represents a single bond, —SO₂—, —CO—, —O—, —S—, C₁- to C₆-alkylene, C₂- to C₅-alkylidene or C₅- to C₆-cycloalkylidene which can be substituted by C₁- to C₆-alkyl, preferably methyl or ethyl, or represents C₆- to C₁₂-arylene which can optionally be fused with further aromatic rings containing heteroatoms.

X preferably represents a single bond, C₁- to C₅-alkylene, C₂- to C₅-alkylidene, C₅- to C₆-cyclo-alkylidene, —O—, —SO—, —CO—, —S—, —SO₂—,

or a radical of the general formula (1b) or (1c)

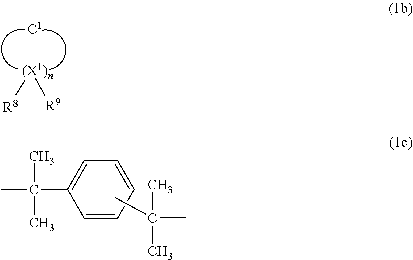

wherein
R⁸ and R⁹ can be chosen individually for each X′ and independently of one another denote hydrogen or C₁ to C₆-alkyl, preferaby hydrogen, methyl or ethyl, and
X¹ represents carbon, and
n represents an integer from 4 to 7, preferably 4 or 5, with the proviso that on at least one atom X¹, R⁸ and R⁹ are simultaneously alkyl.

Examples of such dihydroxyaryl compounds are bisphenols belonging to the group of the dihydroxydiphenyls, bis(hydroxyphenyl)alkanes, indane bisphenols, bis(hydroxyphenyl)ethers, bis(hydroxyphenyl)sulfones, bis(hydroxyphenyl)ketones and α,α′-bis(hydroxyphenyl)-diisopropylbenzenes.

Particularly preferred bisphenols belonging to the above-mentioned groups of compounds are 2,2-bis-(4-hydroxyphenyl)-propane (bisphenol A), tetraalkyl bisphenol A, 4,4-(meta-phenylenediisopropyl)diphenol (bisphenol M), 4,4-(para-phenylenediisopropyl)diphenol, N-phenyl-isatin bisphenol, 1,1-bis-(4-hydroxyphenyl)-3,3,5-trimethylcyclohexane, bisphenols of the 2-hydrocarbyl-3,3-bis(4-hydroxyaryl)phthalimidine type, in particular 2-phenyl-3,3-bis(4-hydroxyphenyl)phthalimidine, and optionally mixtures thereof.

Most particularly preferred bisphenols belonging to the above-mentioned groups of compounds are 2,2-bis-(4-hydroxyphenyl)-propane (bisphenol A), tetraalkylbisphenol A, 4,4-(meta-phenylenediisopropyl)diphenol (bisphenol M), 4,4-(para-phenylenediisopropyl)diphenol, 1,1-bis-(4-hydroxyphenyl)-3,3,5-trimethylcyclohexane (BP-TMC) and optionally mixtures thereof.

Particular preference is given to homopolycarbonates based on 2,2-bis-(4-hydroxyphenyl)-propane (bisphenol A) or 1,1-bis-(4-hydroxyphenyl)-3,3,5-trimethylcyclohexane and copolycarbonates based on the monomers 2,2-bis-(4-hydroxyphenyl)-propane (bisphenol A) and 1,1-bis-(4-hydroxyphenyl)-3,3,5-trimethylcyclohexane.

For the preparation of polycarbonates that are preferred according to the invention, the dihydroxyaryl compounds are reacted with carbonic acid derivatives.

Suitable carbonic acid derivatives are, for example, phosgene or diaryl compounds selected from the group diphenyl carbonate, dimethyl carbonate, 4-tert-butylphenyl-phenyl carbonate, di-(4-tert-butylphenyl)carbonate, biphenyl-4-yl-phenyl carbonate, di-(biphenyl-4-yl)carbonate, 4-(1-methyl-1-phenylethyl)-phenyl-phenyl carbonate, di-[4-(1-methyl-1-phenylethyl)-phenyl]carbonate and di-(methylsalicylate)carbonate.

Particularly preferred carbonic acid derivatives are phosgene or, in the melt transesterification process, diphenyl carbonate or dimethyl carbonate.

Polyester carbonates are preferably obtained by reaction of the dihydroxyaryl compounds already mentioned, at least one aromatic dicarboxylic acid and optionally at least one carbonic acid derivative. Suitable aromatic dicarboxylic acids are, for example, phthalic acid, terephthalic acid, isophthalic acid, 3,3′- or 4,4′-diphenyldicarboxylic acid and benzophenonedicarboxylic acids. A portion, preferably up to 80 mol %, particularly preferably from 20 to 50 mol %, of the carbonate groups in the polycarbonates can be replaced by aromatic dicarboxylic acid ester groups.

The polycarbonates can be branched in a deliberate and controlled manner by the use of small amounts of branching agents. Suitable branching agents are, for example: phloroglucinol, 4,6-dimethyl-2,4,6-tri-(4-hydroxyphenyl)-2-heptene; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-bis-(4-hydroxyphenyl)-cyclohexyl]-propane; 2,4-bis-(4-hydroxyphenyl-isopropyl)-phenol; 2,6-bis-(2-hydroxy-5′-methyl-benzyl)-4-methylphenol; 2-(4-hydroxyphenyl)-2-(2,4-dihydroxyphenyl)-propane; hexa-(4-(4-hydroxyphenyl-isopropyl)-phenyl)-orthoterephthalic acid ester; tetra-(4-hydroxyphenyl)-methane; tetra-(4-(4-hydroxyphenyl-isopropyl)-phenoxy)-methane; α,α,′α″-tris-(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)-methyl)-benzene and in particular: 1,1,1-tri-(4-hydroxyphenyl)-ethane and bis-(3-methyl-4-hydroxyphenyl)-2-oxo-2,3-dihydroindole.

The 0.05 to 2 mol %, based on dihydroxyaryl compounds used, of branching agents or mixtures of branching agents which are optionally to be employed concomitantly can be used together with the dhydroxyaryl compounds or added at a later stage of the synthesis.

As chain terminators there are preferably used phenols such as phenol, alkylphenols such as cresol and 4-tert-butylphenol, chlorophenol, bromophenol, cumylphenol or mixtures thereof. They are preferably used in amounts of from 1 to 20 mol %, preferably from 2 to 10 mol %, per mol of dihydroxyaryl compound. Preferred chain terminators are phenol, 4-tert-butylphenol or cumylphenol.

Chain terminators and branching agents can be added to the syntheses separately or together with the dihydroxyaryl compounds.

Polycarbonates that are preferred according to the invention for layer A are the homopolycarbonate based on 2,2-bis-(4-hydroxyphenyl)-propane (bisphenol A), the homopolycarbonate based on 1,1-bis-(4-hydroxyphenyl)-3,3,5-trimethylcyclohexane and the copolycarbonates based on the two monomers 2,2-bis-(4-hydroxyphenyl)-propane (bisphenol A) and 1,1-bis-(4-hydroxyphenyl)-3,3,5-trimethylcyclohexane. The homopolycarbonate based on 2,2-bis-(4-hydroxyphenyl)-propane (bisphenol A) is particularly preferred.

The polycarbonate can additionally comprise stabilisers. Suitable stabilisers are, for example, phosphines, phosphites or Si-containing stabilisers as well as further compounds described in EP-A 0 500 496. Examples which may be mentioned are triphenyl phosphites, diphenylalkyl phosphites, phenyldialkyl phosphites, tris-(nonylphenyl)phosphite, tetrakis-(2,4-di-tert-butylphenyl)-4,4′-biphenylene diphosphonite and triaryl phosphite. Triphenylphosphine and tris-(2,4-di-tert-butylphenyl)phosphite are particularly preferred.

Layer A of the multilayer products according to the invention can further comprise from 0.01 to 0.5 wt. % of the esters or partial esters of mono- to hexa-hydric alcohols, in particular of glycerol, pentaerythritol or Guerbet alcohols.

Monohydric alcohols are, for example, stearyl alcohol, palmityl alcohol and Guerbet alcohols. A dihydric alcohol is, for example, glycol. A trihydric alcohol is, for example, glycerol. Tetrahydric alcohols are, for example, pentaerythritol and mesoerythritol. Pentahydric alcohols are, for example, arabitol, ribitol and xylitol. Hexahydric alcohols are, for example, mannitol, glucitol (sorbitol) and dulcitol.

The esters are preferably the monoesters, diesters, triesters, tetraesters, pentaesters and hexaesters or mixtures thereof, in particular random mixtures, of saturated, aliphatic C₁₀- to C₃₆-monocarboxylic acids and optionally hydroxy-monocarboxylic acids, preferably with saturated, aliphatic C₁₄- to C₃₂-monocarboxylic acids and optionally hydroxy-monocarboxylic acids.

The commercially available fatty acid esters, in particular of pentaerythritol and of glycerol, can contain <60% different partial esters as a result of their preparation.

Saturated, aliphatic monocarboxylic acids having from 10 to 36 carbon atoms are, for example, capric acid, lauric acid, myristic acid, palmitic acid, stearic acid, hydroxystearic acid, arachinic acid, behenic acid, lignoceric acid, cerotinic acid and montanic acid. Preferred saturated, aliphatic monocarboxylic acids having from 14 to 22 carbon atoms are, for example, myristic acid, palmitic acid, stearic acid, hydroxystearic acid, arachinic acid and behenic acid. Particular preference is given to saturated, aliphatic monocarboxylic acids such as palmitic acid, stearic acid and hydroxystearic acid.

The saturated, aliphatic C₁₀- to C₃₆-carboxylic acids and the fatty acid esters are either known as such in the literature or can be prepared by processes known in the literature. Examples of pentaerythritol fatty acid esters are those of the particularly preferred monocarboxylic acids mentioned above.

Particular preference is given to esters of pentaerythritol and of glycerol with stearic acid and palmitic acid. Particular preference is given also to esters of Guerbet alcohols and of glycerol with stearic acid and palmitic acid and optionally hydroxystearic acid.

The polycarbonates can additionally comprise organic dyes, inorganic colouring pigments, fluorescent dyes and/or optical brightening agents, preferably fluorescent dyes and/or organic dyes.

According to the invention, layer A contains no electroplatable vinyl polymer, preferably no acrylonitrile-butadiene-styrene copolymer (ABS).

In particularly preferred embodiments, layer A comprises a plastics composition comprising at least 80 wt. %, particularly preferably at least 90 wt. %—based on the total weight of the plastics composition—of at least one polycarbonate or of a blend comprising polycarbonate. According to the invention, however, the blend preferably contains no electroplatable vinyl polymer, that is to say vinyl polymer that can be metallised by means of electroplating, preferably no acrylonitrile-butadiene-styrene copolymer (ABS).

Particularly preferred blends comprising polycarbonate are those comprising polycarbonate and at least one poly- or copoly-condensation product of terephthalic acid, such as, for example and preferably, poly- or copoly-ethylene terephthalate (PET or CoPET), glycol-modified PET (PETG) or poly- or copoly-butylene terephthalate (PBT or CoPBT) or poly- or copoly-ethylene naphthalate (PEN or CoPEN).

According to the invention, the vinyl polymers are electroplatable plastics materials, that is to say plastics materials that can be metallised by means of electroplating.

According to the invention they are preferably polymers of one or more, preferably at least two, ethylenically unsaturated monomers selected from ethylene, propylene, vinyl acetate, styrene, α-methylstyrene, o- and/or m- and/or p-substituted styrenes, acrylonitrile, methacrylonitrile, methyl methacrylate, maleic anhydride, N-substituted maleimides, chloroprene, 1,3-butadiene, isoprene, C₁-C₁₈-alkyl acrylates and C₁-C₁₈-alkyl methacrylates.

Particularly suitable vinyl polymers are:
rubber-free vinyl polymers (A.1)
rubber-containing vinyl polymers, for example graft copolymers of vinyl monomers on a rubber (A.2)
mixtures of rubber-free (A.1) and rubber-containing (A.2) vinyl polymers.

Preferred vinyl polymers A.1 are copolymers of, on the one hand, styrene, α-methylstyrene, ortho- and/or meta- and/or para-substituted styrene or mixtures of these monomers (A.1.1) and, on the other hand, acrylonitrile, methacrylonitrile, methyl methacrylate, maleic anhydride, N-substituted maleimide or mixtures of these monomers (A.1.2).

These copolymers preferably comprise from 50 to 98 wt. % A.1.1 and from 50 to 2 wt. % A.1.2.

Particularly preferred copolymers A.1 are those of styrene, acrylonitrile and optionally methyl methacrylate, of α-methylstyrene, acrylonitrile and optionally methyl methacrylate, and of styrene, α-methylstyrene, acrylonitrile and optionally methyl methacrylate.

The most well known are styrene-acrylonitrile copolymers, which can be prepared by radical polymerisation, in particular by emulsion, suspension, solution or mass polymerisation. The copolymers A.1 preferably have molecular weights M_{w} (weight average, determined by light scattering or sedimentation) of from 15,000 to 200,000.

Further particularly preferred copolymers A.1 are randomly synthesised copolymers of styrene and maleic anhydride, which can be prepared from the corresponding monomers, for example, by a continuous mass or solution polymerisation with incomplete conversions. Their composition can be varied within wide limits They preferably contain from 5 to 25 wt. % repeating units derived from maleic anhydride.

Instead of styrene, these polymers can also comprise o- and/or m- and/or p-substituted styrenes, such as p-methylstyrene, vinyltoluene, 2,4-dimethylstyrene and other substituted styrenes, such as α-methylstyrene.

The rubber-containing vinyl polymers A.2 include, for example, graft copolymers with rubber-elastic properties, which are obtainable substantially from at least two, preferably at least three, of the following monomers: chloroprene, 1,3-butadiene, isoprene, styrene, acrylonitrile, ethylene, propylene, vinyl acetate, C₁-C₁₈-alkyl acrylates and C₁-C₁₈-alkyl methacrylates. Such polymers are described in “Methoden der Organischen Chemie” (Houben-Weyl), Vol. 14/1, Georg Thieme-Verlag, Stuttgart, 1961, pages 393-406 and in C. B. Bucknall, “Toughened Plastics”, Appl. Science Publishers, London 1977, pages 66 to 106. Preferred polymers A.2 are partially crosslinked and have gel contents of over 20 wt. %, preferably over 40 wt. %, in particular over 60 wt. % (measured in toluene).

Preferred rubber-containing vinyl polymers A.2 are graft copolymers of:

A.2.1 from 5 to 95 parts by weight, preferably from 30 to 80 parts by weight, of a mixture of
A.2.1.1 from 50 to 95 parts by weight styrene, α-methylstyrene, ortho-, meta- and/or para- or halo-styrene, or ortho-, meta- and/or para-methylstyrenes, methyl methacrylate or mixtures of these compounds, and
A.2.1.2 from 5 to 50 parts by weight acrylonitrile, methacrylonitrile, methyl methacrylate, maleic anhydride, C₁-C₄-alkyl- or phenyl-N-substituted maleimides or mixtures of these compounds on
A.2.2 from 5 to 95 parts by weight, preferably from 20 to 70 parts by weight, rubber polymer having a glass transition temperature below −10° C.

Particularly preferred graft copolymers A.2 are, for example, polybutadienes, butadiene/styrene copolymers and acrylate rubbers grafted with styrene and/or acrylonitrile and/or alkyl acrylates or alkyl methacrylates, preferably polybutadienes, butadiene/styrene copolymers grafted with styrene and acrylonitrile and optionally additionally alkyl acrylates or alkyl methacrylates; polybutadienes, butadiene/styrene or butadiene/acrylonitrile copolymers, polyisobutenes or polyisoprenes grafted with acrylic or methacrylic acid alkyl esters, vinyl acetate, acrylonitrile, styrene and/or alkylstyrenes, as are described in DE-A 2 348 377, page 4, line 14 to page 5, line 2, preferably polybutadienes, butadiene/styrene or butadiene/acrylonitrile copolymers grafted with styrene and acrylonitrile and optionally additionally with acrylic or methacrylic acid alkyl esters, vinyl acetate and/or alkylstyrenes.

Most particularly preferred rubber-containing vinyl polymers A.2 are acrylonitrile-butadiene-styrene copolymers (ABS copolymers).

Particularly preferred graft copolymers A.2 are obtainable by graft polymerisation of
α. from 10 to 70 wt. %, preferably from 15 to 50 wt. %, in particular from 20 to 40 wt. %—based on the graft copolymer A.2—of acrylic acid esters or methacrylic acid esters or from 10 to 70 wt. %, preferably from 15 to 50 wt. %, in particular from 20 to 40 wt. %, of a mixture of from 10 to 50 wt. %, preferably from 20 to 35 wt. %, acrylonitrile, acrylic acid ester or methacrylic acid ester, particularly preferably acrylonitrile, and from 50 to 90 wt. %, preferably from 65 to 80 wt. %, styrene—wt. % are based on the total weight of the mixture of acrylonitrile, acrylic acid ester or methacrylic acid ester and styrene—(as graft base A.2.1) on
β. from 30 to 90 wt. %, preferably from 50 to 85 wt. %, in particular from 60 to 80 wt. %—based on graft polymer A.2—of a butadiene polymer with at least 50 wt. %, based on β, of butadiene radicals (as graft base A.2.2),

wherein the gel content of the graft base β is preferably at least 40 wt. % (measured in toluene), the degree of grafting G is from 0.15 to 0.55 and the mean particle diameter d50 of the graft polymer A.2 is from 0.05 to 2 μm, preferably from 0.1 to 0.6 μm.

Acrylic acid esters or methacrylic acid esters a are esters of acrylic acid or methacrylic acid and monohydric alcohols having from 1 to 18 carbon atoms. Particular preference is given to methyl methacrylate, ethyl methacrylate, propyl methacrylate, n-butyl acrylate, tert-butyl acrylate and tert-butyl methacrylate.

The butadiene polymer β can comprise, in addition to butadiene radicals, up to 50 wt. %, based on β, of radicals of other ethylenically unsaturated monomers, such as styrene, acrylonitrile, C₁-C₄-alkyl esters or acrylic or methacrylic acid (such as methyl acrylate, ethyl acrylate, methyl methacrylate, ethyl methacrylate), vinyl esters and/or vinyl ethers). Polybutadiene is preferred.

In the graft polymerisation, it is known that the graft monomers are not polymerised completely onto the graft base; graft polymers A.2, however, include products which are obtained by polymerisation of the graft monomers in the presence of the graft base.

The degree of grafting G is the weight ratio of grafted graft monomers to the graft base (dimensionless number).

The mean particle diameter d₅₀ is the diameter below which in each case 50 wt. % of the particles lie. It can be determined by means of ultracentrifuge measurement (W. Scholtan, H. Lange, Kolloid, Z. and Z. Polymere 250 (1972), pages 782 to 796).

Further particularly preferred rubber-containing vinyl polymers A.2 are graft copolymers of from 20 to 90 wt. %, based on A.2, of acrylate rubber having a glass transition temperature T_{g} below −20° C. as graft base A.2.2 and
ε. from 10 to 80 wt. %, based on A.2, of at least one polymerisable, ethylenically unsaturated monomer, the homo- or co-polymers of which formed in the absence of A.2.2 have a glass transition temperature T_{g} of more than 25° C., as graft monomers A.2.1.

The glass transition temperature T_{g} can be determined by means of differential scanning calorimetry (DSC) according to standard ISO 113557-2 at a heating rate of 10 K/min with definition of the T_{g} as the mid-point temperature (tangent method).

The acrylate rubbers ti of the polymers A.2 are preferably polymers of acrylic acid alkyl esters, optionally with up to 40 wt. %, based on τ, of other polymerisable, ethylenically unsaturated monomers. The preferred polymerisable acrylic acid esters include C₁-C₈-alkyl esters, for example methyl, ethyl, butyl, n-octyl and 2-ethylhexyl esters; haloalkyl esters, preferably halo-C₁-C₈-alkyl esters, such as chloroethyl acrylate, and mixtures of these monomers.

For crosslinking, monomers having more than one polymerisable double bond can be copolymerised. Preferred examples of crosslinking monomers are esters of unsaturated monocarboxylic acids having from 3 to 8 carbon atoms and unsaturated monohydric alcohols having from 3 to 12 carbon atoms or saturated polyols having from 2 to 4 OH groups and from 2 to 20 carbon atoms, such as ethylene glycol dimethacrylate, allyl methacrylate; polyunsaturated heterocyclic compounds, such as trivinyl and triallyl cyanurate, polyfunctional vinyl compounds, such as di- and tri-vinylbenzenes; but also triallyl phosphate and diallyl phthalate.

Preferred crosslinking monomers are allyl methacrylate, ethylene glycol dimethacrylate, diallyl phthalate and heterocyclic compounds which contain at least three ethylenically unsaturated groups.

Particularly preferred crosslinking monomers are the cyclic monomers triallyl cyanurate, triallyl isocyanurate, trivinyl cyanurate, triacryloylhexahydro-s-triazine, triallylbenzenes.

The amount of crosslinking monomers is preferably from 0.02 to 5 wt. %, in particular from 0.05 to 2 wt. %, based on the graft base τ.

In the case of cyclic crosslinking monomers having at least three ethylenically unsaturated groups, it is advantageous to limit the amount to less than 1 wt. % of the graft base τ.

Preferred “other” polymerisable, ethylenically unsaturated monomers which can optionally be used together with the acrylic acid esters for the preparation of the graft base are acrylonitrile, styrene, α-methylstyrene, acrylamides, vinyl C₁-C₆-alkyl ethers, methyl methacrylate, butadiene. Preferred acrylate rubbers as graft base ti are emulsion polymers which have a gel content of at least 60 wt. %.

Further suitable graft bases according to A.2.2 are silicone rubbers having graft-active sites, as are described in DE-A 37 04 657, column 5, line 21 to column 6, line 52; DE-A 37 04 655 column 5, line 24 to column 6, line 65; DE-A 36 31 540, page 6, line 65 to page 7, line 45; and DE-A 36 31 539, page 6, line 54 to page 7, line 35.

The gel content of the graft base A.2.2 is determined at 25° C. in dimethylformamide (M. Hoffmann, H. Kromer, R. Kuhn, Polymeranalytik 1 and II, Georg-Thieme-Verlag, Stuttgart 1977).

The graft polymers A.2 can be prepared by known processes such as mass, suspension, emulsion or mass-suspension processes.

In particularly preferred embodiments, layer B comprises a plastics composition comprising at least 80 wt. %, particularly preferably at least 90 wt. %—based on the total weight of the plastics composition—of one or more of the vinyl polymers mentioned above, or at least 80 wt. %, particularly preferably at least 90 wt. %, of a blend of one or more of the vinyl polymers mentioned above with one or more polycarbonates. Particularly preferably, layer B comprises a plastics composition comprising at least 80 wt. %, particularly preferably at least 90 wt. %, of one or more acrylonitrile-butadiene-styrene copolymers (ABS copolymers) or at least 80 wt. %, particularly preferably at least 90 wt. %, of a blend of one or more acrylonitrile-butadiene-styrene copolymers (ABS copolymers) with one or more polycarbonates.

Suitable polycarbonates or copolycarbonates for such a blend are preferably those mentioned above for layer A. Polycarbonates that are preferred according to the invention for layer B—in so far as layer B comprises a blend of at least one vinyl polymer and at least one polycarbonate—are the homopolycarbonate based on 2,2-bis-(4-hydroxyphenyl)-propane (bisphenol A), the homopolycarbonate based on 1,1-bis-(4-hydroxyphenyl)-3,3,5-trimethylcyclohexane and the copolycarbonates based on the two monomers 2,2-bis-(4-hydroxyphenyl)-propane (bisphenol A) and 1,1-bis-(4-hydroxyphenyl)-3,3,5-trimethylcyclohexane. The homopolycarbonate based on 2,2-bis-(4-hydroxyphenyl)-propane (bisphenol A) is particularly preferred.

The layer(s) B preferably has or have a total layer thickness of 70 μm or less, preferably of 50 μm or less, particularly preferably of 30 μm or less. Particularly preferably, the plastics film according to the invention comprises only one layer B comprising at least one vinyl polymer.

Owing to the small layer thickness of the layer(s) B, the light transmission of the plastics film according to the invention is improved considerably as compared with moulded bodies of ABS or ABS/polycarbonate blends, so that backlighting can be achieved in an energy-saving manner even with relatively weak light sources, such as, for example, LEDs.

Preferably, the plastics film according to the invention has a transmission in the visible wavelength range of more than 70%, preferably of more than 80%. The visible wavelength range of light extends over the wavelength range from 380 to 780 nm.

It can be advantageous and preferred for some applications for the plastics film according to the invention to have, in addition to good transmission in the visible wavelength range, low haze scatters light that passes through only slightly. Accordingly, it can be advantageous and preferred for the plastics film according to the invention to have, in addition to good transmission in the visible wavelength range, low haze which is preferably less than 20, particularly preferably less than 13, most particularly preferably less than 10.

The plastics film according to the invention is preferably a plastics film that has been produced by means of coextrusion of layer(s) A and of layer(s) B and optionally of further layers between those layers A and B. Particularly thin layers B can thereby advantageously particularly preferably be produced.

In preferred embodiments of the invention, the surface of layer B of the plastics film according to the invention preferably has a surface roughness (R3z value) of less than 1 μm, preferably of less than 0.5 μm. The surface roughness can be measured according to DIN EN ISO 4287 using a Hommel T1000. Such a preferred surface roughness is advantageous in particular when particularly thin and high-gloss metal layers are to be applied by means of electroplating, because it does not impair the gloss effect of the metal layer as a result of visually perceptible unevenness or scattering effects.

The plastics film according to the invention is suitable for the production of metallised, in particular partially metallised, plastics mouldings, preferably of backlightable plastics mouldings. Such plastics mouldings can be used in particular for applications in the automotive interiors sector, the aircraft interiors sector, the railway vehicle interiors sector, the household sector, the computer sector and the electronics sector. Suitable fields of application are, for example, operating, decorative or display elements, for example with backlit symbols, frames, buttons, etc.

The plastics film according to the invention can be metallised by means of electroplating in such a manner that the deposition of the metal advantageously takes place only on layer B. Therefore, it is not necessary in the metallisation of the film by means of electroplating to cover all or part of the rear side of the film in order to prevent metal deposition.

In the production of metallised, in particular partially metallised, plastics mouldings, the metallisation can be carried out according to the invention in such a manner that the optionally formed film is first metallised, preferably partially metallised, by means of electroplating and then the moulding takes place by back moulding of the film with a thermoplastic plastic. Alternatively, however, the finished non-metallised moulding can first be produced by forming the plastics film according to the invention and back moulding it with a non-thermoplastic plastic and only then carrying out the metallisation, preferably partial metallisation, by means of electroplating. The plastics film according to the invention can be printed—preferably prior to forming—on the layer A side. Such printing can be single-coloured or multicoloured and offers the advantage that coloured or multicoloured backlit mouldings can be produced in a simple manner.

The present invention accordingly also provides a process for the production of an optionally formed plastics film that is wholly or partially metallised on one side and has a transmission in the visible wavelength range of more than 50%, preferably of more than 70%, particularly preferably of more than 80%, in the optionally non-metallised regions, characterised in that
A) an optionally formed plastics film comprising at least one layer B comprising at least one vinyl polymer and at least one layer A comprising at least one polycarbonate is coextruded, the layer(s) B having a total layer thickness of 100 μm or less and the plastics film having a total layer thickness of 1000 μm or less, and
B) the plastics film obtained according to process step A) is metallised by means of electroplating on the layer B side.

In step B), the plastics film obtained according to process step A) is preferably only partially metallised by means of electroplating on the layer B side.

The present invention further provides a process for the production of metallised, preferably partially metallised, plastics mouldings, characterised in that
a) a plastics film comprising at least one layer B comprising at least one vinyl polymer and at least one layer A comprising at least one polycarbonate is coextruded, the layer(s) B having a total layer thickness of 100 μm or less and the plastics film having a total layer thickness of 1000 μm or less and a transmission in the visible wavelength range of more than 50%, preferably of more than 70%, particularly preferably of more than 80%,
b) the plastics film obtained according to process step a) is optionally printed on the side that has layer A,
c) the plastics film obtained according to process step a) or b) is optionally formed,
d) after forming, the plastics film obtained according to process step c) is back moulded on the side that has layer A, or on the printed side, with a thermoplastic plastic, preferably with a non-electroplatable thermoplastic plastic, and
e) after the back moulding, the plastics moulding obtained according to process step d) is metallised, preferably partially metallised, by means of electroplating on the layer B side.

Printing of the plastics film on the side that has layer A can be carried out using all printing inks that withstand the subsequent process steps of forming and back moulding with thermoplastic plastics. They are preferably printing inks based on polyacrylate and/or polycarbonate. Such printing inks are known to the person skilled in the art and are described, for example, in WO-A 2009/138217.

Process step c) is preferably carried out following process step a) or b).

The process steps of the forming of plastics films and back moulding with thermoplastic plastics are known to the person skilled in the art.

A preferred process for the forming of plastics films is so-called high-pressure forming (HPF process), which is known to the person skilled in the art and is described, for example, in WO-A 2009/043539 and EP-A 371 425.

Suitable thermoplastic plastics for the back moulding are in principle all conventional injection moulding materials, such as, for example, polyesters, polycarbonates, polycarbonate blends, polystyrene, ABS, ABS blends, polyamide, PVC and PMMA. A preferred material for the back moulding is polycarbonate or various polycarbonate blends. Polycarbonates or polycarbonate blends offer the advantage according to the invention of good light transmission and excellent adhesion to layer A of the film according to the invention. In addition, polycarbonates or polycarbonate blends are suitable in particular for the back moulding of the film according to the invention because the deposition of metals thereon by electroplating is not possible so that, even in the case of the electroplating of the finished plastics moulding, partial or complete covering of the rear side, and consequently the subsequent removal of such a covering, are not necessary.

All metals which can be deposited by electroplating come into consideration for the metallisation. For example and preferably, they can be chromium, gold, cadmium, copper, brass, nickel, silver, zinc or tin. Combinations of a plurality of metal coats of such metals can also be applied. Particularly preferred metals are copper, nickel and chromium. Chromium is most particularly preferred, in particular for high-gloss chromium and matt chromium coatings.

The metallisation of plastics surfaces by means of electroplating is known to the person skilled in the art (see e.g. DE 102 08 674 A1). The individual process steps are described by way of example below.

The plastics moulded bodies (film or moulding) to be electroplated are first placed on a holder—generally a so-called electroplating frame—and contacted. Contacting preferably takes place in such a manner that the contact devices in the case of partial electroplating does not take place in the region of the surfaces that are later metal-free and transparent, i.e. visible.

For the electroplating of plastics films or plastics mouldings, it is known to be necessary to subject the plastics material to a suitable pretreatment by coating the surface regions that are to be metallised, for subsequent electrolytic coating, with an electrically conductive layer that adheres well. This can be carried out by various processes, such as, for example, physical gas-phase deposition (PVD), plasma enhanced chemical vapour deposition (PECVD), thermal injection, chemical etching processes or plasma coating.

In particular for the preparation of electroplatable vinyl polymers based on acrylonitrile-butadiene-styrene copolymer (ABS), the preparation can be carried out by means of known processes such as, for example, colloidal processes or direct metallisation. In the colloidal process, the sequence of the process steps is preferably etching, activation, acceleration, chemical nickel coating or copper coating, and in direct metallisation by etching, activation, crosslinking and application of a thin metal layer, whereby a thin metal layer, preferably only up to a few μm thick, is applied in both cases. Nickel layers with layer thicknesses of less than 1 μm and copper layers of less than 3 μm can thereby be applied. Other metal layers are also possible.

The preparation of ABS-based vinyl polymers by means of the colloidal process takes place, for example, by roughening the surface, for example in a chromium/sulfuric acid etch (400 g/l CrO₃ and 400 g/l H₂SO₄), the working temperature preferably being 60° C. in the case of ABS and 69° C. in the case of ABS/PC blends, a constituent of the ABS, the butadiene, is oxidised from the surface, and cavities in the microscopic range are formed. Palladium nuclei which are surrounded by a tin shell and form a colloid in the so-called activator are introduced into the cavities. In a further step, the tin shell, which ensures that the nuclei adhere in the cavities, is removed in the accelerator (tetrafluoroboric acid 17 g/l) at a temperature of preferably from 45 to 50° C. until the nucleus is free. The high standard potential of the palladium ensures that, in the subsequent step, chemical (external current-free) nickel plating in a nickel bath (nickel sulfate; ammonia and sodium hypophosphite as the electron donor), the reaction starts. A reducing agent, which is itself oxidised, releases the electrons necessary for the nickel deposition. The first thin, conductive nickel layer thus forms which, by the filling of the cavities, has a strong mechanical interlocking with the plastics material and adheres correspondingly well.

The thin metal layers so applied or thin conductive layers produced by different processes then form the base for the deposition of the further metal layer(s) by electroplating. Metal deposition by electroplating is carried out solely in the regions that have a thin conductive layer, such as, for example, the thin metal layer described above.

In the case of partial electroplating, there are several possibilities for purposively preventing metal deposition by electroplating in specific areas, for example in order subsequently to be able to backlight those areas.

It is possible, for example, purposively to remove part of layer B. This can be carried out, for example, by suitable laser processes. It is further possible purposively to coat regions of layer B with a non-conductive and also non-electroplatable transparent coating, preferably in the form of a protective lacquer, which preferably remains on the plastics surface even after the electroplating. Both variants would be used before layer B is prepared for the electroplating.

It is further possible purposively to remove part of the thin conductive layers, such as, for example, the thin metal layers, applied as preparation for the electroplating. This can be carried out, for example, by means of laser ablation or by means of etching processes, it being possible to free more precise regions of the conductive layers by means of laser ablation. Such and further processes are known and described, for example, in DE 102 08 674 A1.

Preferably, therefore, the plastics film or the plastics moulding is pretreated prior to the partial electroplating in such a manner that
a thin metal layer is applied chemically or by electroplating to the layer B side, and the thin metal layer is then partially removed, or
layer B is partially removed, or
layer B is partially coated with a non-electroplatable transparent coating, preferably in the form of a laquer.

The following examples serve to explain the invention by way of example and are not to be interpreted as limiting.

### EXAMPLES

The following materials were used for the examples:

Polycarbonate type Makrolon® 3108 from Bayer MaterialScience AG (high-viscosity bisphenol A polycarbonate (melt flow rate (MFR) 6.5 g/10 min according to ISO 1133 at 300° C. and 1.2 kg) without UV stabilisation) for the production of the polycarbonate-containing layer in Examples 1 to 3

Acrylonitrile-butadiene-styrene (ABS) copolymer type Novodur® P2HE from Lanxess Deutschland GmbH (MFR of 7 g/10 min according to ISO 1133 at 220° C. and 10 kg) for the production of the vinyl polymer-containing layer in Examples 1 to 3 and the production of the ABS sheet in Example 4

Polycarbonate/ABS blend type Bayblend® T 65 from Bayer MaterialScience AG (MFR 11 g/10 min according to ISO 1133 at 260° C. and 5 kg) for the production of the film in Example 5

### Example 1

### (According to the Invention): Production of a Coextruded Film According to the Invention

The system used to produce the coextruded film(s) comprises:
an extruder for extrusion of the layer comprising at least one polycarbonate, with a screw having a diameter (D) of 60 mm and a length of 33 D. The screw has a degassing zone;
a coextruder for application of the layer comprising at least one vinyl polymer, with a screw having a length of 30 D and a diameter of 30 mm;
a melt pump;
a deflection head;
a special coextrusion sheet die having a width of 450 mm;
a three-roll smoothing calender with horizontal roll arrangement, the third roller being pivotable by +/−45° relative to the horizontal;
a roller belt
thickness measurement;
a device for applying protective film to both sides;
a take-off device;
a winding station.

The granulate of the base material Makrolon® 3108 was fed to the filling hopper of the extruder, and the granulate of the Novodur® P2HE was fed to the filling hopper of the coextruder. Melting and feeding of the material took place in the cylinder/screw plastification system of the extruder or coextruder. The two material melts were brought together in the coextrusion die. The melt passed from the die to the smoothing calender, the rolls of which had the temperature mentioned in Table 3. Final forming and cooling of the film took place on the smoothing calender (consisting of three rolls). For structuring of the film surfaces, a rubber roll (4th or surface), a polished chromium roll (1st surface) or a structured steel roll (2nd and 6th surface) were used. The rubber roll used for structuring the film surface is disclosed in U.S. Pat. No. 4,368,240 of Nauta Roll Corporation.

For the coextruded film according to the invention, two chromium rolls were used in the smoothing calender in order to produce high-gloss film surfaces on both sides. The following process parameters were chosen:

TABLE 1

| Temperature of the main extruder | 308° C. +/− 5° C. | |
|---|---|---|
| Temperature of the coextruder | 266° C. +/− 5° C. | |
| Temperature of the deflection head | 285° C. +/− 5° C. | |
| Temperature of the die | 300° C. +/− 5° C. | |
| Speed of the main extruder | 39 | min−¹ |
| Speed of the coextruder | 38 | min⁻¹ |
| Temperature of roll 1 | 110° | C. |
| Temperature of roll 2 | 85° | C. |
| Temperature of roll 3 | 115° | C. |
| Take-off speed | 9.4 | m/min |

A transparent coextruded film which was glossy on both sides and had a total layer thickness of 260 μm and a layer thickness of the coextruded ABS copolymer layer of 25 μm was obtained. The optical properties of the film are described in Example 6.

### Example 2

### (According to the (Invention): Production of a Coextruded Film According to the Invention

The film according to the invention was coextruded on the coextrusion system according to Example 1 from Makrolon® 3108 and Novodur® P2HE under the following conditions:

TABLE 2

| Temperature of the main extruder | 312° C. +/− 5° C. | |
|---|---|---|
| Temperature of the coextruder | 266° C. +/− 5° C. | |
| Temperature of the deflection head | 290° C. +/− 5° C. | |
| Temperature of the die | 300° C. +/− 5° C. | |
| Speed of the main extruder | 72 | min⁻¹ |
| Speed of the coextruder | 38 | min⁻¹ |
| Temperature of roll 1 | 110° | C. |
| Temperature of roll 2 | 85° | C. |
| Temperature of roll 3 | 115° | C. |
| Take-off speed | 9.4 | m/min |

A transparent coextruded film which was glossy on both sides and had a total layer thickness of 380 μm and a layer thickness of the coextruded ABS copolymer layer of 25 μm was obtained. The optical properties of the film are described in Example 6.

### Example 3

### (According to the Invention): Production of an Extruded Film According to the Invention

System for producing the coextruded film(s) comprises
an extruder for extrusion of the layer comprising at least one polycarbonate, with a screw having a diameter (D) of 105 mm and a length of 41 D. The screw has a degassing zone;
a coextruder for application of the layer comprising at least one vinyl polymer, with a screw having a length of 44 D and a diameter of 35 mm;
a deflection head;
a special coextrusion sheet die having a width of 1500 mm;
a three-roll smoothing calender with horizontal roll arrangement, the third roller being pivotable by +/−45° relative to the horizontal;
a roller belt
thickness measurement;
a device for applying protective film to both sides;
a take-off device;
a winding station.

The granulate of the base material Makrolon® 3108 was fed to the filling hopper of the extruder, and the granulate of the Novodur® P2HE was fed to the filling hopper of the coextruder. Melting and feeding of the material took place in the cylinder/screw plastification system of the extruder or coextruder. The two material melts were brought together in the coextrusion die. The melt passed from the die to the smoothing calender, the rolls of which had the temperature mentioned in Table 3. Final forming and cooling of the film took place on the smoothing calender. For smoothing of the surface, polished chromium rolls were used. The film was then transported through a take-off device, the protective film was applied to both sides, and then the film was wound up.

For the coextruded film according to the invention, two chromium rolls were used in the smoothing calender in order to produce high-gloss film surfaces on both sides. The following process parameters were chosen:

TABLE 3

| Temperature of the main extruder | 270° C. +/− 5° C. | |
|---|---|---|
| Temperature of the coextruder | 234° C. +/− 5° C. | |
| Temperature of the deflection head | 275° C. +/− 5° C. | |
| Temperature of the die | 280° C. +/− 5° C. | |
| Speed of the main extruder | 54 | min⁻¹ |
| Speed of the melt pump | 25 | min⁻¹ |
| Speed of the coextruder | 14 | min⁻¹ |
| Speed of the melt pump | 7 | min⁻¹ |
| Temperature of roll 1 | 80° | C. |
| Temperature of roll 2 | 120° | C. |
| Temperature of roll 3 | 111° | C. |
| Take-off speed | 12 | m/min |

A 1310 mm wide transparent coextruded film which was glossy on both sides and had a total layer thickness of 375 μm and a layer thickness of the coextruded ABS copolymer layer of 25 μm was obtained. The optical properties of the film are described in Example 6.

### Example 4

### (Not According to the Invention): Production of an ABS Plastics Sheet not According to the Invention

A sheet 2.4 mm thick was produced from Novodur® P2HE on a commercially available injection moulding machine.

The optical properties of the sheet are described in Example 6.

### Example 5

### (Not According to the Invention): Production of a One-Layer Plastics Film not According to the Invention From a Polycarbonate/ABS Blend

A 375 μm thick film which was glossy on both sides was extruded from Bayblend T 65.

The optical properties of the film are described in Example 6.

### Example 6

### Optical Properties and Electroplating Properties

In order to determine the transmission in the visible wavelength range (light transmission (Ty)) (C2° (according to ASTM D 1003), an UltraScan PRO from Hunter Associates Laboratory, Inc.

was used. For the haze determination (according to ASTM D 1003), a Hazegard Plus from Byk-Gardner was used.

The results obtained are summarised in Table 4.

TABLE 4

| | Light transmission [%] | Haze [%] |
|---|---|---|
| Film from Example 1 | 87.9 | 5.0 |
| Film from Example 2 | 87.7 | 5.8 |
| Film from Example 3 | 86.5 | 12.3 |
| Sheet from Example 4 (not | 65.5 | 15.1 |
| according to the invention) | | |
| Film from Example 5 (not | 68.5 | 13.2 |
| according to the invention) | | |

It is clear from the optical measurements that only the films according to the invention from Examples 1 to 3 have a high light transmission. That is the requirement in order that the films, after electroplating and freeing of the areas not covered with metal, can be irradiated in particular also with an energy-saving light source. The good irradiation even with energy-saving light sources is additionally also promoted by the low haze of the films according to the invention.

In addition, the films according to the invention can be metallised by means of electroplating on the ABS layer side. This metallisation can be carried out selectively on the ABS layer side without corresponding covering or masking of the other side, whereas the sheet from Example 4 and the film from Example 5 would be metallised on both sides without corresponding protection, for example in the form of masking.

1. A plastic film comprising:
at least one layer A comprising at least one polycarbonate; and
at least one layer B comprising at least one vinyl polymer,
wherein said layer A comprising polycarbonate and said layer B comprising at least one vinyl polymer have been coextruded, and said layer B comprising at least one vinyl polymer has a layer thickness of 100 μm or less and said plastic film has a transmission in a visible wavelength range of more than 50%,
capable of being used in producing a metallised component.

2. A plastic film according to claim 1, wherein layer B comprises as at least one vinyl polymer an acrylonitrile-butadiene-styrene copolymer (ABS).

3. A plastic film according to claim 1, wherein said plastic film has a transmission in a visible wavelength range of more than 70%, optionally of more than 80%.

4. A plastic film according to claim 1, wherein said layer B has a total layer thickness of 70 μm or less, optionally of 50 μm or less or optionally −20 μm or less.

5. A plastic film according to claim 1, wherein the total thickness of said plastic film is 1000 μm or less, optionally 750 μm or less.

6. A plastic film according to claim 1, wherein a surface of layer B has a surface roughness of less than 1 μm.

7. A plastic film according to claim 1, wherein metallisation is carried out by partial electroplating.

8. A plastic film according to claim 1, wherein said plastic film is capable of being used for metallisation of plastic moulding, optionally of a backlightable plastic moulding.

9. A plastic film according to claim 8, wherein said plastic moulding is for an automotive interior sector, an aircraft interior sector, a railway vehicle interior sector, a household sector, a computer sector and/or an electronics sector.

10. A process for producing an optionally formed plastic film that is wholly or partially metallised on one side and has a transmission in the visible wavelength range of more than 50% in optionally non-metallised regions, comprising:
A) Coextruding an optionally formed plastic film comprising at least one layer B comprising at least one vinyl polymer and at least one layer A comprising at least one polycarbonate, the layer B having a total layer thickness of 100 μm or less and said plastic film having a total layer thickness of 1000 μm or less,
B) Metallising the plastic film obtained according to process A) by electroplating on the layer B side.

11. The process according to claim 10, wherein in B) said plastic film obtained according to process A) is only partially metallised by electroplating on the layer B side.

12. The process according to claim 10, wherein said plastic film obtained according to process A) has a transmission in a visible wavelength range of more than 70%, optionally of more than 80%, in optionally non-metallised regions.

13. A process for producing a wholly or partially metallised plastic moulding, comprising:
a) Coextruding a plastic film comprising at least one layer B comprising at least one vinyl polymer and at least one layer A comprising at least one polycarbonate, the layer B having a total layer thickness of 100 μm or less and said plastic film having a total layer thickness of 1000 μm or less and a transmission in the visible wavelength range of more than 50%,
b) Optionally printing the plastic film obtained according to process step a) is on a side that comprises layer A,
c) Optionally forming the plastic film obtained according to process step a) or b),
d) after forming, back moulding the plastic film obtained according to process c) on a side that comprises layer A, or on a printed side, with a thermoplastic plastic, optionally with a non-electroplatable thermoplastic plastic,
e) after the back moulding, wholly or partially metallising the plastic moulding obtained according to process d) is on a layer B side by electroplating.

14. The process according to claim 10, wherein said plastic film or the plastic moulding is pretreated prior to partial electroplating in such a manner wherein:
a thin metal layer is applied chemically or by electroplating to layer B side, and the thin metal layer is then partially removed, or
layer B is partially removed, or
layer B is partially coated with a non-electroplatable coating.

15. An electroplatable plastic film comprising:
at least one layer A comprising at least one polycarbonate; and
at least one layer B comprising at least one vinyl polymer,
wherein said layer A comprising polycarbonate and said layer B comprising at least one vinyl polymer have been coextruded, and the layer B comprising at least one vinyl polymer has a layer thickness of 100 μm or less and the plastic film has a transmission in a visible wavelength range of more than 50%.

16. A plastic film according to claim 2, wherein said plastic film has a transmission in a visible wavelength range of more than 70%, optionally of more than 80%.

17. The process according to claim 11, wherein said plastic film obtained according to process A) has a transmission in a visible wavelength range of more than 70%, optionally of more than 80%, in optionally non-metallised regions.

18. The process according to claim 13, wherein said plastic film and/or the plastic moulding is pretreated prior to partial electroplating in such a manner wherein:
a thin metal layer is applied chemically or by electroplating to layer B side, and the thin metal layer is then partially removed, or
layer B is partially removed, or
layer B is partially coated with a non-electroplatable coating.
